(19) United States
(12) Patent Application Publication
(10) Pub. No.: US 2021/0094844 A1
(43) Pub. Date: Apr. 1, 2021

(54) DEVICES FOR TREATING TAP WATER

(71) Applicant: VITACLEAN, London (GB)

(72) Inventors: Sara DOUGLAS, Secaucus, NJ (US); Kristina VELKOVA, Secaucus, NJ (US)

(21) Appl. No.: 16/589,599

(22) Filed: Oct. 1, 2019

(51) Int. Cl. C02F 1/28; B05B 1/18; B05B 15/40; B05B 1/30

(52) U.S. Cl. CPC C02F 1/281; B05B 1/18; B05B 15/40; C02F 2101/20; C02F 2303/22; C02F 2303/185; C02F 2303/04; B05B 1/3026

(57) ABSTRACT

The present disclosure provides a valve assembly for treating tap water. The valve assembly includes a housing fluidically connected to a water source. The housing includes an inlet port for receiving water from the water source and an outlet port for discharging the water routed into the housing. A filter assembly including a casing is disposed within the housing. The casing is configured with a first surface and a second surface. The first surface and the second surface are configured with a plurality of openings, wherein the first surface is configured for receiving water routed into the housing and the second surface for discharging a treated water from the casing. A shungite filter element is disposed within the casing, the shungite filter element configured for treating the water routed to the casing, the treated water discharged from the outlet port via the outlet opening.

### TECHNICAL FIELD

The present disclosure relates generally to devices for treating tap water and, more particularly, to the devices including a shungite filter element for treating the tap water.

### BACKGROUND

At present, consumers across the world have become aware of the issues with their municipality-treated tap water. Specifically, there is a growing concern regarding presence of chemicals such as, but not limited to, chlorine, in the tap water. Research regarding these chemicals has shown that prolonged exposure or contact to such chemicals may lead to serious health consequences.

One of the scenarios, where the consumers are likely to be in contact with the chemicals of the tap water is during a shower. Generally, in the shower, a hot water spray is discharged by a shower assembly for usage of the consumer. The hot water spray from the shower assembly may instantaneously activate the chemicals within the tap water. As such, the consumer may directly contact the activated chemical within the tap water, which may lead to serious health consequences.

Additionally, apart from the chemicals, the tap water also includes scale deposits, which are an indicator of ‘hard water’. The scales primarily include calcium and magnesium. The scales may form white crust over the skin of the consumer after the shower, which is aesthetically unpleasing, even though the scales are harmless to the consumer's health to a large extent.

To address the common issues in the tap water, conventional filters made of carbon block have been incorporated within showerhead devices. The carbon block filters are configured to filter out the chemicals from the tap water during use. However, these carbon block filters may not be configured to filter all the chemicals within the tap water. Moreover, the carbon black filter requires complex techniques to manufacture, which makes the device employing the carbon black filters expensive.

Therefore, there is a need for techniques which can overcome one or more limitations stated above in addition to providing other technical advantages.

### SUMMARY

Various embodiments of the present disclosure provide a valve assembly for treating tap water. The valve assembly includes a housing fluidically connected to a water source. The housing includes an inlet port for receiving water from the water source and an outlet port for discharging the water routed into the housing. A filter assembly including a casing is disposed within the housing. The casing is configured with a first surface and a second surface. The first surface and the second surface are configured with a plurality of openings, wherein the first surface is configured for receiving water routed into the housing and the second surface for discharging a treated tap water from the casing. A shungite filter element is disposed within the casing, the shungite filter element configured for treating the tap water routed to the casing, the treated tap water discharged from the outlet port via the second surface.

In an embodiment, the present disclosure provides a showerhead assembly for treating the tap water. The assembly includes the housing fluidically connected to the water source. The housing includes the inlet port for receiving water from the water source and the outlet port for discharging the water routed into the housing. The filter assembly including a casing is disposed within the housing. The casing is configured with the first surface and the second surface. The first surface and the second surface are configured with the plurality of openings, wherein the first surface is configured for receiving water routed into the housing and the second surface for discharging the treated tap water from the casing. The shungite filter element is disposed within the casing, the shungite filter element configured for treating the tap water routed to the casing, the treated tap water discharged from the outlet port via the second surface. A spray plate is mounted to the outlet port and configured with a plurality of apertures. The spray plate is configured to spray the treated tap water discharged from the outlet port.

In an embodiment, the present disclosure provides a hand shower assembly. The assembly includes the housing fluidically connected to the water source. The housing including the inlet port for receiving water from the water source and the outlet port for discharging the water routed into the housing. The filter assembly including a casing is disposed within the housing. The casing is configured with the first surface and the second surface. The first surface and the second surface are configured with the plurality of openings, wherein the first surface is configured for receiving water routed into the housing and the second surface for discharging a treated tap water from the casing. The shungite filter element is disposed within the casing, the shungite filter element configured for treating the tap water routed to the casing, the treating water discharged from the outlet port via the second surface.

### BRIEF DESCRIPTION OF FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1A is a schematic view of a valve assembly for filtering tap water, with a valve plate in a closed position, in accordance with an example embodiment of the present disclosure;

FIG. 1B is a schematic view of a valve assembly for filtering tap water, with a valve plate in an open position, in accordance with an example embodiment of the present disclosure;

FIG. 2 is a schematic view of a casing of the valve assembly, in accordance with an example embodiment of the present disclosure;

FIG. 3 is a schematic view of the casing including a shungite filter element, in accordance with an example embodiment of the present disclosure;

FIG. 4 is an exploded view of a showerhead assembly including the shungite filter element, in accordance with an example embodiment of the present disclosure; and

FIG. 5 is an exploded view of a hand shower assembly including the shungite filter element, in accordance with an example embodiment of the present disclosure.

The drawings referred to in this description are not to be understood as being drawn to scale except if specifically noted, and the drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, the description of the present disclosure is set forth without any loss of generality to, without imposing limitations upon, the present disclosure.

### Overview

Various embodiments of the present disclosure provide a valve assembly for treating tap water. The valve assembly includes a housing fluidically connected to a water source. The housing includes an inlet port for receiving water from the water source and an outlet port for discharging the water routed into the housing. A filter assembly is configured within the housing for treating the water routed into the housing. The filter assembly includes a casing which is disposed within the housing. The casing is configured with a first surface and a second surface. The first surface and the second surface are configured with a plurality of openings. The first surface is configured for receiving water routed into the housing, while the second surface is configured for discharging a treated water from the casing. The casing may be configured with a first segment and a second segment, wherein the first segment is fastened to the second segment to from the casing. A shungite filter element is disposed either on the first segment and the second segment of the casing. The shungite filter element is configured to treat the water routed to the casing, thereby treating the tap water. The treated water is discharged from the outlet port via the outlet opening for use. This configuration of the valve assembly ensures that the tap water, particularly the shower water, is contamination-free, thereby preventing health consequences to a consumer.

The present disclosure also provides a showerhead assembly configured with the filter assembly. The present disclosure also provides a hand shower assembly configured with the filter assembly.

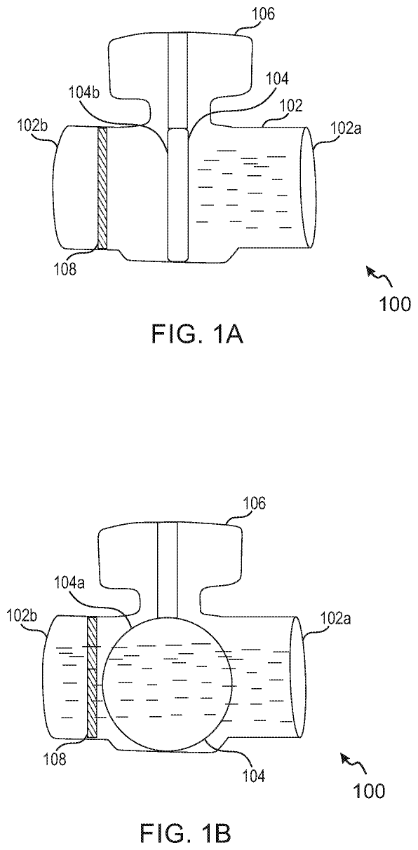

Various embodiments of a valve assembly are explained in a detailed manner, herein with reference to FIGS. 1A-1B to 5.

FIGS. 1A and 1B illustrate a schematic view of a valve assembly 100, in accordance with some example embodiments of the present disclosure. The valve assembly 100 is configured to treat tap water received from a water source (not shown in Figures), to filter out micro-organisms or bacteria, to prevent health consequences to a consumer (not shown in Figures) during use. The valve assembly 100 includes a housing 102 fluidically connected to the water source (not shown in Figures) for receiving the water. The housing 102 may define a hollow chamber therein, for receiving the water, while also encompassing other components of the valve assembly 100. The housing 102 includes an inlet port 102a, which is fluidically coupled to the water source, for receiving the water. The inlet port 102a may be coupled to the water source through a conduit or a pipe or any other suitable means as per design feasibility and requirement. The housing 102 also includes an outlet port 102b configured to discharge the tap water routed into the housing 102. The outlet port 102b may be connected to a container (not shown in Figures) for storing the tap water received from the housing 102 or may be suitably used by the consumer for use. In one configuration, the shape and configuration of the inlet port 102a and the outlet port 102b may be selected based on feasibility and requirement. In one implementation, the inlet port 102a and the outlet port 102b may be circular in shape.

The assembly further includes a valve plate 104 disposed within the housing 102. The valve plate 104 is configured to be operable between an open position 104a (for e.g. as shown in FIG. 1B) and a closed position 104b (for e.g. as shown in FIG. 1A) via a switch member 106 extending from the valve plate 104. In the open position 104a, the valve plate 104 is configured to allow flow or discharge of the tap water from the inlet port 102a to the outlet port 102b. In the closed position 104b, the valve plate 104 is configured to restrict the flow or discharge of the tap water from the inlet port 102a to the outlet port 102b. As such, the valve plate 104 may be disposed at a suitable location within the housing 102, as per design feasibility and requirement. In one implementation, the valve plate 104 may be located proximal to the inlet port 102a or proximal to the outlet port 102b or in a central portion (not indicated in the Figures) of the housing.

Further, the switch member 106 may be connected to suitable actuation means such as but not limiting to a hydraulic actuation system, a pneumatic actuation system and the like, or may be accessible to the consumer for operating the valve plate 104 between the open position 104a and the closed position 104b. Thus, the switch member 106 may be manually actuated by the consumer suitably, as per requirement. In one implementation, for ease of operating the valve plate 104, the switch member 106 may be located in a location readily accessible to the user. In one configuration, the switch member 106 may be coupled to a handle (not shown in Figures) which may be located at a consumer preferred location, for ease of operating the assembly 100.

In one configuration, the valve plate 104 may be a plate-like structure, with dimensions identical to that of a hollow portion (not shown in the Figures) in the closed position 104b. This configuration ensures that a leak-proof connection is obtained, when the valve plate 104 is in the closed position 104b. In one implementation, the configuration of the valve plate 104 may correspond to the configuration of the housing 102. In another implementation, the configuration of the valve plate 104 may correspond to the type of actuation of the switch member 106 i.e. whether the switch member 106 is actuated via a hydraulic actuator, a pneumatic actuator or a motor or any other suitable means as per requirement. In one configuration, the valve plate 104 may be a disc-like structure confirming to the dimensions of the hollow portion of the housing 102.

The assembly 102 further includes a filter assembly 108 disposed within the housing 102. The filter assembly 108 is configured to treat the tap water received by the inlet port 102a, by treating or filtering the contaminants or chemicals contained in the tap water. The filter assembly 108 includes a casing 202, within which a shungite filter element 204 is disposed.

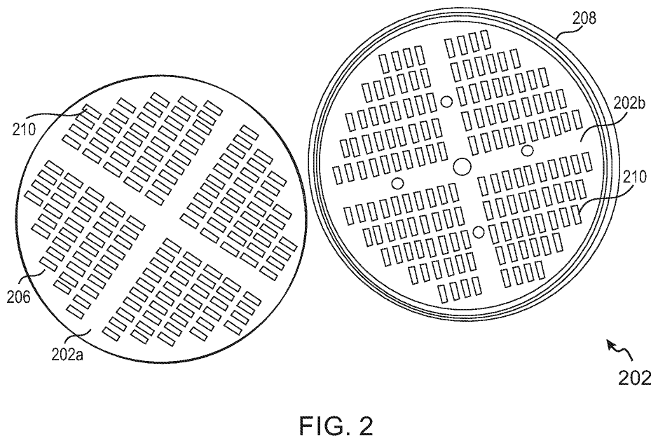

Referring to FIG. 2 in conjunction with FIG. 1A, the casing 202 includes a first surface 202a configured for receiving the tap water and a second surface 202b for discharging the tap water routed into the casing 202. The casing 202 may also define a hollow portion within for enclosing the filter element 204. In one implementation, the casing 202 may include a first segment 206 and a second segment 208. The first segment 206 may include the first surface 202a for receiving the tap water, while the second segment 208 may include the second surface 202b for discharging the tap water routed into the casing 202. The first segment 206 and the second segment 208 are coupled to each other to form the casing 202. In one configuration, the first segment 206 may be coupled to the second segment 206 via conventional means selected from one of a snap-fit mechanism, a twist-lock mechanism, a fastening mechanism or any other mechanism as per design feasibility and requirement. In one implementation, the first segment 206 may include an annular protrusion (not shown in Figures), while the second segment 208 may include an annular cutout (not shown in Figures) corresponding to the configuration of the annular protrusion to enable snap-fitting of the first segment 206 and the second segment 208. Further, the first segment 206 and the second segment 208 may be a U-shaped shell structure within which, the filter element 204 may be accommodated or mounted. The shell structures of the first segment 206 and the second segment 208 forms the casing 202 of a cylindrical type. In one configuration, the casing 202 is of a modular construction in order to enable replacement of the shungite filter element 204 as per requirement. In an embodiment, the housing 102 and the casing 202 may be made of materials selected from at least one of a metallic material, a non-metallic material, a composite material or any other material as per design feasibility and requirement. In one configuration, the casing 202 includes an internal axis A-A′, which is aligned coaxially with a longitudinal axis X-X′ of the housing 102. In another configuration, the internal axis A-A′ of the casing 202 may be inclined at a predetermined angle with the longitudinal axis X-X′ of the housing 102 as per design feasibility and requirement.

In one implementation, the first surface 202a may be the surface adjacent to the inlet port 102a and the second surface 202b may be the surface adjacent to the outlet port 102b. In one configuration, the first surface 202a and the second surface 202b may be selected as per design feasibility and requirement, of flow properties of the tap water therein.

The first surface 202a and the second surface 202b is configured with a plurality of openings 210. The openings 210 may be randomly configured on the first surface 202a and the second surface 202b. The openings 210 is provided to disperse the tap water entering the casing 202. The dispersion enables the tap water to fill in the casing 202. In one implementation, the size and configuration of the openings 210 may be selected based on the flow requirements of the tap water. In one configuration, the first surface 202a with the openings 210 may be configured as an inlet opening of the casing 202, while the second surface 202b with the opening 210 may be configured as an outlet opening of the casing 202.

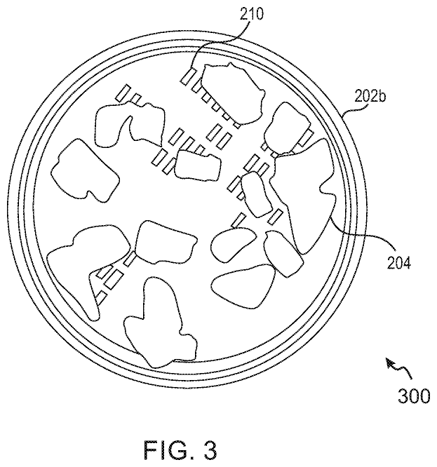

Referring to FIG. 3 in conjunction with FIG. 2, the filter assembly 108 includes the shungite filter element 204 disposed within the casing 202. The shungite filter element 204 may be in the form of blocks or rocks disposed within the casing 202 as already described in paragraph 27 of the description. The shungite filter element 204 may be configured with composition of about 98% of carbon, which is highly efficient in filtering toxins or for treating the tap water. The carbon content in the shungite filter element 204 attract and neutralize waterborne contaminants including bacteria, nitrates, metals and pesticides. In one implementation, the configuration of the openings 210 complement the treatment process of the tap water by dispersing the tap water throughout the casing 202. This configuration ensures that the tap water contacts maximum surface area of the shungite filter element 204 for treatment. In another configuration, the shungite filter element 204 may be configured with sheet-like structure or any other suitable size and shapes via conventional shaping means, as per design feasibility and requirement.

In an embodiment, the valve assembly 100 may be mounted and used as per requirement of the consumer. In one configuration, the valve assembly 100 may be mounted to the water source via a threaded fitting, or an adhesive bonding or any other means as per design feasibility and requirement.

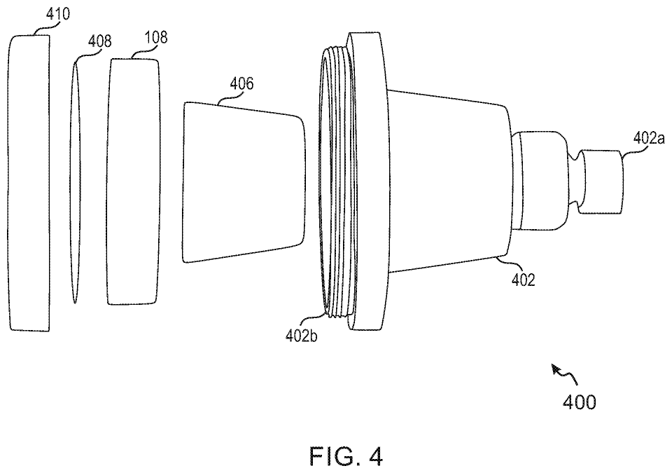

FIG. 4 illustrates an exploded view of a showerhead assembly 400, in accordance with an example embodiment of the present disclosure. The assembly 400 is configured with the filter assembly 108 for treating the tap water used for a shower by the consumer.

The assembly 400 includes a showerhead 402 configured to be mountable onto a wall or a ceiling by conventional mounting means. The showerhead 402 acts as the housing 102 for receiving and encompassing the components of the assembly 400. The showerhead 402, in one configuration may be trapezoidal in configuration, or may be of any other shape as per design feasibility and requirement. The showerhead 402 includes an inlet port 402a connectable to a water source which may be a cold water source or a hot water source as per design feasibility and requirement. The inlet port 402a, similar to the inlet port 102a, is fluidically coupled to the water source by a pipe or a conduit suitably.

The assembly 400 includes a valve plate (similar to the configuration of valve plate 104 shown in FIGS. 1A and 1B) configured within the housing 402. The valve plate is operable between an open position and a closed position (not shown in Figures), similar to the valve plate 104. Further, the valve plate shares identical characteristics as that of the valve plate 104, which is already described in the description pertaining to FIGS. 1A and 1B. That is, the valve plate is configured to control the flow of the tap water from the water source into the housing 402. The valve plate may be coupled to a switch member (not shown in Figures), similar to the switch member 106 for operating the valve plate 104 suitably. In one configuration, the embodiments described for the valve plate 104 and switch member 106 may suitably apply to the valve plate and the switch member.

The showerhead 402 further includes the filter assembly 108 disposed therein. The filter assembly 108 as already described in description with reference to FIGS. 1A and 1B, includes the shungite filter element 204 for treating the tap water routed into the showerhead 402. The treated tap water ensures that the consumer is free from contamination and thereby preventing health consequences.

The assembly 400 also includes a vitamin-C filter 406 which may be mounted adjacent to the filter assembly 108. The vitamin-C filter 406 is configured to moisturize the tap water to synthesize collagen and elasten, thereby improving health of the skin. In one configuration, the vitamin-C filter 406 may be located above the filter assembly 108, so that the tap water is moisturized before treatment. In another configuration, the vitamin-C filter 406 may be located below the filter assembly 108, so that the treated tap water is moisturized after treatment.

The assembly 400 further includes a microbial cloth 408 disposed within the housing 402. The microbial cloth 408 is configured to filter out pathogenic micro-organisms in the treated tap water. In one configuration, the microbial cloth 408 is located below the vitamin-C filter 406 for filtering the pathogenic micro-organisms in the treated tap water.

The housing 402 further includes an outlet port 402b for discharging the treated water. For dispersing or scattering the treated water, a spray plate 410 is mounted to the outlet port 402b. The spray plate 410 includes a plurality of apertures (not shown in Figures) for dispersing or scattering the treated water.

In an embodiment, the components in the showerhead assembly 400 may be made of materials selected from one of a metallic material, a non-metallic material or any other material as per design feasibility and requirement. In one implementation, the shape and configuration of the components in the showerhead assembly 400 may be selected based on design feasibility and requirement. In one configuration, the variations found in conventional showerhead assemblies regarding the orientation with the wall, adjustable mounting with the wall and the like, are suitable applicable to the assembly 400, without deviating from the scope of the disclosure.

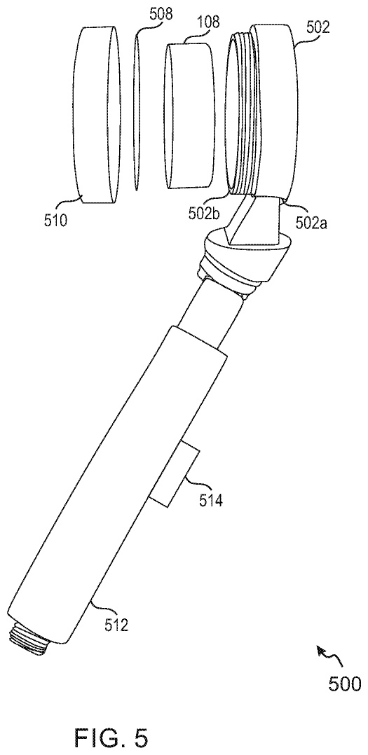

FIG. 5 illustrates an exploded view of a hand shower assembly 500, in accordance with an example embodiment of the present disclosure. The assembly 500 is configured with the filter assembly 108 for treating the tap water used for the consumer.

The assembly 500 includes a showerhead 502 configured to be supported onto a wall by conventional mounting means (not shown in Figures). A handle member 512 extends from the showerhead assembly 502. The handle member 512 is configured to be held by the consumer during use. The handle member 512 may be placed or rested on the wall via a groove or a seat member (not shown in Figures) mounted to the wall. The showerhead 502 acts as the housing 102 for receiving and encompassing the components of the assembly 500. The showerhead 502, in one configuration may be cylindrical in configuration, or may be of any other shape as per design feasibility and requirement. The showerhead 502 includes an inlet port 502a connectable to a water source which may be a cold water source or a hot water source as per design feasibility and requirement. The inlet port 502a, similar to the inlet port 102a, is fluidically coupled to the water source by a pipe or a conduit suitably. The pipe or the conduit may extend through the handle member 512, suitably, for ergonomic purposes.

The assembly 500 includes a valve plate (similar to the configuration of valve plate 104 shown in FIGS. 1A and 1B) configured within the housing 502. The valve plate is operable between an open position and a closed position (not shown in Figures), similar to the valve plate 104. Further, the valve plate shares identical characteristics as that of the valve plate 104, which is already described in the description pertaining to FIGS. 1A and 1B. That is, the valve plate is configured to control the flow of the tap water from the water source into the housing 502. The valve plate may be coupled to a switch member 514, similar to the switch member 106 for operating the valve plate 104 suitably. The switch member 514 may be configured on the handle member 512 or on any other location as per design feasibility and requirement. In one configuration, the embodiments described for the valve plate 104 and switch member 106 may suitably apply to the valve plate and the switch member.

The showerhead 502 further includes the filter assembly 108 disposed therein. The filter assembly 108 as already described in description with reference to FIGS. 1A and 1B, includes the shungite filter element 204 for treating the tap water routed into the showerhead 402. The treated tap water ensures that the consumer is free from contamination and thereby preventing health consequences.

In an embodiment, the assembly 500 may also includes a vitamin-C filter similar to the vitamin-C filter 406, for moisturizing the tap water.

The assembly 500 further includes a microbial cloth 508 disposed within the housing 502. The microbial cloth 508 is configured to filter out pathogenic micro-organisms in the treated tap water. In one configuration, the microbial cloth 508 is located below the vitamin-C filter for filtering the pathogenic micro-organisms in the treated tap water.

The housing 502 further includes an outlet port 502b for discharging the treated water. For dispersing or scattering the treated water, a spray plate 510 is mounted to the outlet port 502b. The spray plate 510 includes a plurality of apertures (not shown in Figures) for dispersing or scattering the treated water.

In an embodiment, the components in the showerhead assembly 500 may be made of materials selected from one of a metallic material, a non-metallic material or any other material as per design feasibility and requirement. In one implementation, the shape and configuration of the components in the hand shower assembly 500 may be selected based on design feasibility and requirement. In one configuration, the variations found in conventional showerhead assemblies regarding the orientation with the wall, adjustable mounting with the wall and the like, are suitably applicable to the assembly 500, without deviating from the scope of the disclosure.

The benefits and advantages described above may relate to one embodiment or may relate to several embodiments. The embodiments are not limited to those that solve any or all of the stated problems or those that have any or all of the stated benefits and advantages.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A valve assembly, comprising:
a housing fluidically connected to a water source, the housing including an inlet port for receiving a tap water from the water source and an outlet port for discharging the tap water routed into the housing; and
a filter assembly, comprising:
a casing disposed within the housing, the casing configured with a first surface and a second surface, each of the first surface and the second surface configured with a plurality of openings, wherein the first surface is configured for receiving the tap water routed into the housing and the second surface for discharging a treated tap water from the casing, wherein the casing is configured with a first segment and a second segment, wherein the first segment is coupled to the second segment using snap-fit mechanism to form the casing, and wherein an internal axis of the casing is inclined at a predetermined angle with a longitudinal axis of the housing, and
a shungite filter element disposed in form of rocks either on the first segment or the second segment of the casing, the shungite filter element configured for treating the tap water routed to the casing, the treated tap water discharged from the outlet port via the second surface.

2. The valve assembly as claimed in claim 1 further comprising a valve plate disposed within the housing, the valve plate operable between an open position and a closed position.

3. The valve assembly as claimed in claim 2, wherein the valve plate in the open position is configured to allow discharge of the treated tap water from the valve assembly.

4. The valve assembly as claimed in claim 2, wherein the valve plate in the closed position is configured to restrict discharging of the treated tap water from the valve assembly.

5. (canceled)

6. A showerhead assembly, comprising:
a housing fluidically connected to a water source, the housing including an inlet port for receiving a tap water from the water source and an outlet port for discharging the tap water routed into the housing, wherein the housing is a showerhead configured to be mounted onto a wall or a ceiling;
a filter assembly, comprising:
a casing disposed within the housing, the casing configured with a first surface and a second surface, the first surface and the second surface configured with a plurality of pores, wherein the first surface is configured for receiving the tap water routed into the housing and the second surface for discharging a treated tap water from the casing, and wherein an internal axis of the casing is inclined at a predetermined angle with a longitudinal axis of the housing, and
a shungite filter element disposed in form of rocks within the casing, the shungite filter element configured for treating the tap water routed to the casing, the treated tap water discharged from the outlet port via the second surface; and
a spray plate mounted to the outlet port and configured with a plurality of apertures, the spray plate configured to spray the treated tap water discharged from the outlet port.

7. The showerhead assembly as claimed in claim 6 further comprising a valve plate disposed within the housing, the valve plate operable between an open position and a closed position.

8. The showerhead assembly as claimed in claim 7, wherein the valve plate in the open position is configured to allow discharge of the treated tap water from the showerhead assembly.

9. The showerhead assembly as claimed in claim 7, wherein the valve plate in the closed position is configured to restrict discharging of the treated tap water from the showerhead assembly.

10. (canceled)

11. The showerhead assembly as claimed in claim 6, further comprising a microbial cloth mounted between the casing and the spray plate, the microbial cloth configured to filter pathogenic micro-organisms in the treated tap water.

12. The showerhead assembly as claimed in the claim 6, further comprising a vitamin-C filter mounted between the casing and the spray plate, the vitamin-C filter configured to introduce the treated tap water routed from the outlet opening with vitamin-C.

13. A hand shower assembly, comprising:
a housing fluidically connected to a water source, the housing including an inlet port for receiving a tap water from the water source and an outlet port for discharging the tap water routed into the housing, wherein the housing is a showerhead of a hand shower, and wherein the showerhead is configured to be supported onto a wall; and
a filter assembly, comprising:
a casing disposed within the housing, the casing configured with a first surface and a second surface, the first surface and the second surface configured with a plurality of pores, wherein the first surface is configured for receiving the tap water routed into the housing and the second surface for discharging a treated tap water from the casing, and wherein an internal axis of the casing is inclined at a predetermined angle with a longitudinal axis of the housing, and
a shungite filter element disposed in form of rocks within the casing, the shungite filter element configured for treating the tap water routed to the casing, the treated tap water discharged from the outlet port via the second surface.

14. The hand shower assembly as claimed in claim 13 further comprising a valve plate disposed within the housing, the valve plate operable between an open position and a closed position by an actuator.

15. The hand shower assembly as claimed in claim 14, wherein the valve plate in the open position is configured to allow discharge of the treated tap water from the hand shower assembly.

16. The hand shower assembly as claimed in claim 14, wherein the valve plate in the closed position is configured to restrict discharging of the treated tap water from the hand shower assembly.

17. (canceled)

18. The hand shower assembly as claimed in claim 13 further comprising a handle member connected to the inlet opening of the housing, the handle member configured to be held by a user and connectable to the water source for routing the tap water into the housing.

19. The valve assembly as claimed in claim 1, wherein the first segment and the second segment is a U-shaped shell structure within which, the shungite filter element is mounted.

20. The valve assembly as claimed in claim 2, wherein the valve plate is a disc-like structure confirming to dimensions of hollow portion of the housing, and wherein the valve assembly further comprises a switch member that extends from the valve plate, wherein configuration of the valve plate is based on a type of actuation of the switch member, and wherein the switch member is actuated via one of: a hydraulic actuator, a pneumatic actuator, and a motor.
